(19) United States
(12) Patent Application Publication
(10) Pub. No.: US 2026/0170969 A1
(43) Pub. Date: Jun. 18, 2026

(54) GROUPING APPARATUS OF GRADED ANSWERS OF DESCRIPTIVE EXAMINATION, GROUPING METHOD OF GRADED ANSWERS OF DESCRIPTIVE EXAMINATION, AND PROGRAM

(71) Applicant: NEC Platforms, Ltd., Kanagawa (JP)

(72) Inventors: Ryo SUZUKI, Kanagawa (JP); Ken TONARI, Kanagawa (JP)

(73) Assignee: NEC Platforms, Ltd., Kanagawa (JP)

(21) Appl. No.: 19/408,471

(22) Filed: Dec. 4, 2025

(30) Foreign Application Priority Data
Dec. 17, 2024 (JP) 2024-221163

(51) Int. Cl. G09B 7/02; G06F 40/268; G06F 40/289

(52) U.S. Cl. CPC G09B 7/02; G06F 40/268; G06F 40/289

(57) ABSTRACT

There is provided a grouping apparatus of graded answers of a descriptive examination which contributes to suppress variation of graded results. A grouping apparatus of graded answers of a descriptive examination includes a reading part which reads graded answer data of a descriptive examination, a morphological analysis part which performs morphological analysis of answer data, a vectorization part which vectorizes result of morphological analysis to an answer sentence vector, a grouping execution part which groups answer data matching rule definition and groups answer data which does not comply with rule definition based on answer sentence vector to generate a group, a group characteristic analysis part which analyzes statistical information of features of group generated, a graded result analysis part which analyzes statistical information of a graded result of each of groups, an output part which outputs statistical information of characteristic of group and statistical information of graded results.

### REFERENCE TO RELATED APPLICATION

The present disclosure is based upon and claims the benefit of the priority of Japanese patent application No. 2024-221163 filed on Dec. 17, 2024, the disclosure of which is incorporated herein in its entirety by reference thereto.

The present disclosure relates to a grouping apparatus of graded answers of a descriptive examination, a grouping method of graded answers of a descriptive examination, and a program.

### BACKGROUND

There is a following document regarding an information processing apparatus as to grading of graded answers of a descriptive examination.

Patent Literature (PTL) 1 relates to detection of grading which may be incorrectly-graded in grading of answers of an examination, or the like.
[PTL 1] Japanese Patent Kokai Publication No: 2023-123121A

### SUMMARY

The following analysis has been made by the present inventors.

In education (or educational site), it is frequently performed that various examinations are conducted answers by examinees for the examinations are graded, and a degree of understanding of the examinee is evaluated, and so on. As to examples of examination questions, there exists a type to select answers by Scantron sheets, for example. On the other hand, descriptive-answer-type examinations are also widely employed, in which questions of a problem-solving type are presented to examinees to require the examinees to make answer by sentences.

It is human beings such as teachers that usually grade answers of descriptive question. In case of an examination which a large number of examinees take, such as an entrance examination and a qualification examination, gradings are performed by a plurality of graders. As a result, for example, there has been a problem that variations of graded results by respective graders occur in spite of similar answers. Furthermore, while the single grader is grading a large number of answers, it is concerned that variations of graded results may occur. In a case where variations of graded results by respective graders occur, there is a problem that fairness for evaluation cannot be maintained.

Therefore, a grader takes time for performing mutual adjustment with other graders or reviewing graded results which have already graded, while taking account of suppressing variation of graded results during grading, whereby burden of a grader who engages in grading is heavy.

PTL 1 is an example of a prior art in which a grading which may have been incorrectly-graded is detected in grading of answers of an examination, or the like. It is, however, required to generate a trained classification model by a machine learning or a deep learning using answer data. Therefore, it is needed to prepare graded answer data for a model generation, adjust hyper parameters for a machine learning or a deep learning, and execute training processings. Accordingly, there was a problem that it takes time until actual using is started.

It is an object of the present disclosure is to provide a grouping apparatus of graded answers of a descriptive examination, a grouping method of graded answers of a descriptive examination, and a program which contribute to suppress variation of graded results.

According to a first aspect of the disclosure, there is provided a grouping apparatus of graded answers of a descriptive examination, comprising:
a reading part which reads graded answer data of a descriptive examination;
a morphological analysis part which performs morphological analysis of the answer data;
a vectorization part which vectorizes a result of the morphological analysis to an answer sentence vector;
a grouping execution part which groups the answer data matching a rule definition and groups the answer data which does not comply with the rule definition based on the answer sentence vector to generate a group(s);
a group characteristic analysis part which analyzes statistical information of features of the group(s) generated;
a graded result analysis part which analyzes statistical information of a graded result of each of the groups; and
an output part which outputs statistical information of characteristic of the group(s) and statistical information of graded results.

According to a second aspect of the disclosure, there is provided a grouping method of graded answers of a descriptive examination, comprising: by a computer,
reading graded answer data of a descriptive examination; performing morphological analysis of the answer data;
vectorizing a result of the morphological analysis to an answer sentence vector;
grouping the answer data matching a rule definition and grouping the answer data which does not comply with the rule definition based on the answer sentence vector to generate a group(s);
analyzing statistical information of features of the group(s) generated;
analyzing statistical information of a graded result of each of the groups;
outputting statistical information of characteristic of the group(s) and statistical information of graded results. This method is associated with a certain machine, which is a computer to perform the method as described above.

According to a third aspect of the disclosure, there is provided a program which causes a computer to perform processings of:
reading graded answer data of a descriptive examination; performing morphological analysis of the answer data;
vectorizing a result of the morphological analysis to an answer sentence vector;
grouping the answer data matching a rule definition and grouping the answer data which does not comply with the rule definition based on the answer sentence vector to generate a group(s);
analyzing statistical information of features of the group(s) generated;
analyzing statistical information of a graded result of each of the groups;
outputting statistical information of characteristic of the group(s) and statistical information of graded results.

The program can be recorded on a computer-readable storage medium. The storage medium may be non-transitory one such as a semiconductor memory, a hard disk, a magnetic recording medium, or an optical recording medium, and so on. Also, in the present disclosure, it is also possible to implement it as a computer program product.

According to the present disclosure, it is possible to provide a grouping apparatus of graded answers of a descriptive examination, a grouping method of graded answers of a descriptive examination, and a program which contribute to suppress variation of graded results.

### BRIEF DESCRIPTION OF DRAWINGS

FIG. 1 is a block diagram illustrating an example of a configuration of a grouping apparatus of graded answers of a descriptive examination and an example of a total system configuration according to the present disclosure.

FIG. 2 is a block diagram illustrating an example of a configuration of a grouping execution part of a grouping apparatus according to the present disclosure.

FIG. 3 is a diagram illustrating an example of a configuration of graded answer data of a descriptive examination according to the present disclosure.

FIG. 4 is a diagram illustrating an example of a configuration of a rule definition according to the present disclosure.

FIG. 5 is a flow diagram of an example of a processing operation of a grouping apparatus according to the present disclosure.

FIG. 6 is a flow diagram illustrating an example of a rule-based grouping processing of a grouping apparatus according to the present disclosure.

FIG. 7 is a flow diagram illustrating an example of a processing of a group analysis of a grouping apparatus according to the present disclosure.

FIG. 8 is a flow diagram illustrating an example of a processing of a group characteristic analysis of a grouping apparatus according to the present disclosure.

FIG. 9 is a flow diagram illustrating an example of a processing of a graded answer analysis of a grouping apparatus according to the present disclosure.

FIG. 10 is a flow diagram illustrating an example of a processing of a re-grouping processing of a grouping apparatus according to the present disclosure.

FIG. 11 is a flow diagram illustrating an example of a processing of a re-grouping analysis of a grouping apparatus according to the present disclosure.

FIG. 12 is a diagram illustrating an example of a calculation of contributions and a cos similarity of a grouping apparatus according to the present disclosure.

FIG. 13 is a diagram illustrating an example of relationships between cos similarity and answer data of a grouping apparatus according to the present disclosure.

FIG. 14 is a diagram illustrating an example of an outline of transition relationship consideration groups of a grouping apparatus according to the present disclosure.

FIG. 15 is a diagram illustrating an example of imagery of group division of a grouping apparatus according to the present disclosure.

FIG. 16 is a diagram illustrating an example in which dimensionality of a space of answer vectors is reduced to two dimensions.

FIG. 17 is a diagram illustrating an example of an analysis of graded results.

FIG. 18 is a diagram illustrating an example of an operation of calculating a cos similarity when increment data is re-grouped.

FIG. 19 is a diagram illustrating an example of an operation of re-grouping of transition relationship consideration groups.

FIG. 20 is a diagram illustrating an example of an operation of re-grouping of transition relationship consideration groups.

FIG. 21 is a diagram illustrating an example of an operation of re-grouping of transition relationship consideration groups.

FIG. 22 is a diagram illustrating an example of an operation of re-grouping of transition relationship consideration groups.

FIG. 23 is a diagram illustrating an example of an operation of re-grouping of transition relationship consideration groups.

FIG. 24 is a diagram illustrating an example of an operation of re-grouping of transition relationship consideration groups.

FIG. 25 is a diagram illustrating a configuration of a computer making up a grouping apparatus according to the present disclosure.

### EXAMPLE EMBODIMENTS

Please note that, in the present disclosure, drawings are associated with one or more example embodiments. Furthermore, each example embodiment described below can be combined with other example embodiments. The present invention is not limited by each example embodiment.

First, an outline of one example embodiment will be described with reference to drawings. Note, in the following outline, reference signs of the drawings are denoted to each element as an example for the sake of convenience to facilitate understanding and are not intended to limit the present invention to modes illustrated by the drawings. An individual connection line between blocks in the drawings, etc., referred to in the following description includes both one-way and two-way directions. A one-way arrow schematically illustrates a principal signal (data) flow and does not exclude bidirectionality.

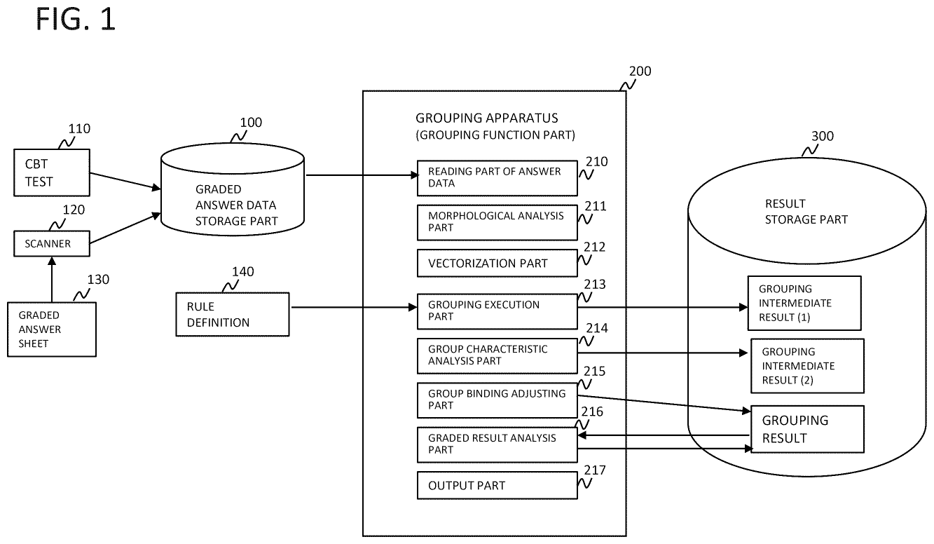

FIG. 1 is a block diagram illustrating an example of a configuration of a grouping apparatus of graded answers of a descriptive examination and an example of a total system configuration according to the present disclosure.

A total system includes a graded answer data storage part 100, a grouping apparatus 200, and a result storage part 300.

A graded answer data storage part 100 stores graded answer data 110 of a CBT (Computer Based Testing) test and answer data which is obtained by reading graded answer sheet 130 by a scanner 120. Answer data includes answer sentences for descriptive examination questions, a graded result (score), an examinee ID.

A grouping apparatus of graded answers of a descriptive examination 200 includes a reading part of answer data 210, a morphological analysis part 211, a vectorization part 212, a grouping execution part 213, a group characteristic analysis part 214, a graded result analysis part 216 and an output part 217.

A reading part 210 reads graded answer data of a descriptive examination from a graded answer data storage part 100.

A morphological analysis part 211 receives answer data, performs a morphological analysis, and stores a result of the morphological analysis in a result storage part 300.

A vectorization part 212 vectorizes the result of the morphological analysis to an answer sentence vector and stores a vectorization result in a result storage part 300.

A grouping execution part 213 reads a rule definition 140, groups the answer data matching the rule definition 140 to generate a group (that is, generates a grouping intermediate result (1) according to the rule definition 140) to store in the result storage part 300.

Note, as an example, a rule definition 140 enumerates information corresponding grading criteria such as NG (No Good) words and amounts of sentences which are not appropriate as answer content.

A grouping execution part 213 groups remained answer data which does not comply with the rule definition based on the answer sentence vector to generate a group(s) and stores a grouping intermediate result (1) in the result storage part 300.

A group characteristic analysis part 214 analyzes statistical information of features of a group(s) generated by the grouping. The group characteristic analysis part 214 analyzes characteristic words for each group and common words to a plurality of groups to analyze statistical information of features of groups which have grouped. Note, the group characteristic analysis part 214 stores an analysis result as a grouping intermediate result (2) in the result storage part 300.

A graded result analysis part 216 analyzes statistical information of a graded result of each group. As an example, statistical analysis for an average, a median, a standard deviation, a maximum value, a minimum value, and an interquartile range are performed from graded results (scores) of answer data of a grouping result and outliers are detected.

An output part 217 outputs statistical information of characteristic of a group and statistical information of graded results. As an example, the output part 217 generates output information to be outputted on a screen of a user terminal and, so on and outputs it.

Furthermore, a grouping apparatus 200 may further include a group binding adjusting part 215. When answer data is increased, the group binding adjusting part 215 adjusts to bind the increased answer data to respective groups of processed answer data. As an example, a grouping result is stored in a result storage part 300.

According to data grouping of the disclosure, it is possible to grouping answer sentences depending on graded results from large amounts of answer data without depending on manpower and without pre-training. Therefore, it is possible to significantly reduce time for preparation of data for model generation and needed for model training.

As above, it is possible to suppress variation of graded results and reduce the burden of a grader. Furthermore, the present disclosure can be utilized to grade answers solved in an exercise by a solver and to assist for raising a score when a score is low.

As described above, according to one example embodiment of the present disclosure, it is possible to provide a grouping apparatus of graded answers of a descriptive examination, a grouping method of graded answers of a descriptive examination, and a program which contribute to suppress variation of graded results.

### First Example Embodiment

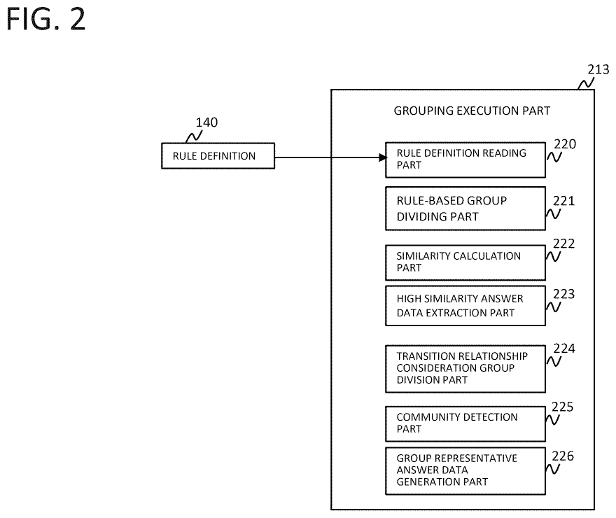

Next, a first example embodiment will be described in detail with reference to drawings. FIG. 1 is a block diagram illustrating an example of a configuration of a grouping apparatus 200 of graded answers of a descriptive examination and an example of a total system configuration according to the present disclosure. FIG. 2 is a block diagram illustrating an example of a configuration of a grouping execution part 213 of a grouping apparatus 200 according to the present disclosure.

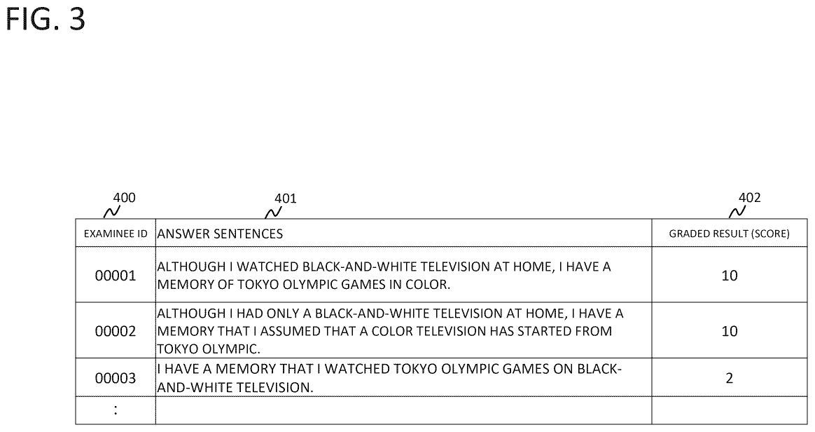

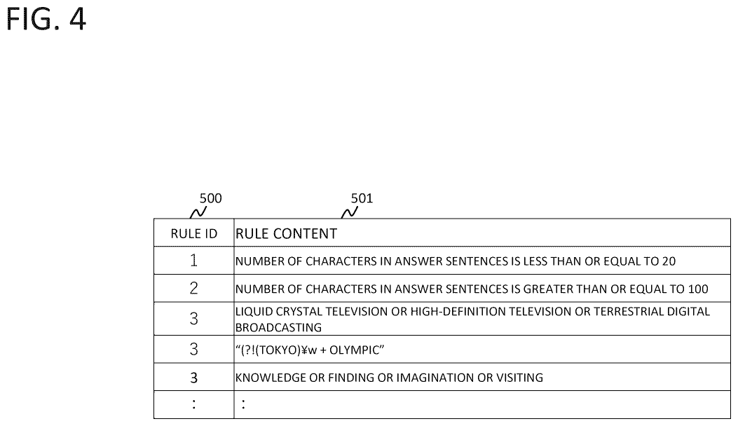

FIG. 3 is a diagram illustrating an example of a configuration of graded answer data of a descriptive examination according to the present disclosure. With reference to FIG. 3, graded answers of a descriptive examination read from a graded answer data storage part 100 by a reading part of answer data 210 is assumed to include answer data including an examinee ID, answer sentences a graded result (score). FIG. 4 is a diagram illustrating an example of a configuration of a rule definition according to the present disclosure.

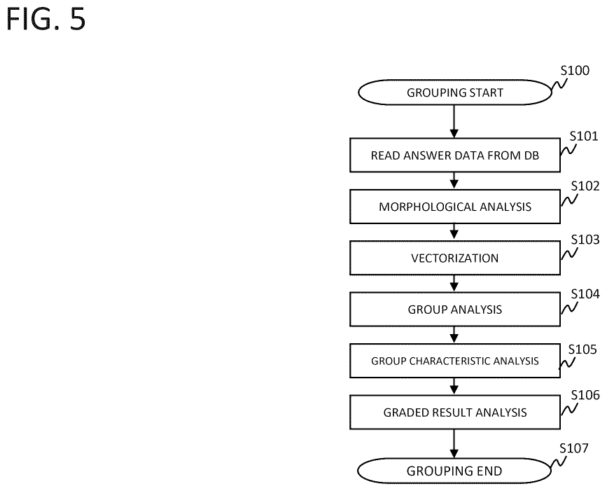

With reference to FIG. 5 to FIG. 9, an example of a processing operation of a grouping apparatus according to the present disclosure will be described. FIG. 5 is a flow diagram of an example of a processing operation of a grouping apparatus according to the present disclosure. With reference to FIG. 5, a processing start at step S100. A reading part of answer data 210 of a grouping apparatus 200 reads data from a graded answer data storage part (also referred to DB) 100 (step S101). A format of data to be read includes an examinee ID, answer sentences a graded result (score) as one example of which is shown in FIG. 3.

A morphological analysis part 211 performs morphological analysis of graded answer data (step S102). Among morphemes acquired as a result, when there are parts of speech which are determined to be unnecessary (particles and auxiliary verbs), parts of speech which are determined to be unnecessary may be excluded. A result of morphological analysis is stored in a result storage part 300.

A vectorization part 212 vectorizes answer sentences which have been morphologically analyzed (step S103). At this time, particular words which is necessary to be included in an answer prescribed by grading criteria may be weighted. In a case where a word(s) is determined to be not important for grouping, a small value may be assigned, and in a case where a word(s) is determined to be important for grouping, a large value may be assigned. A weighted vector may be normalized. For vectorization, any method, such as TF (Term Frequency), TF-IDF (Term Frequency-Inverse Document Frequency), BM25 (Best Matching 25), Word2Vec, Doc2Vec, and so on may be used. In the first example embodiment, description will be made using TF-IDF as an example. Note, it is assumed that vectorized answer sentence is called an answer sentence vector. A result of vectorization is stored in a result storage part 300.

Next, a grouping execution part 213 executes grouping by performing a group analysis (step S104). With reference to FIG. 2, a grouping execution part 213 includes a rule definition reading part 220, a rule-based group dividing part 221, a similarity calculation part 222, a high similarity answer data extraction part 223, a transition relationship consideration group division part 224, a community detection part 225, and a group representative answer data generation part 226.

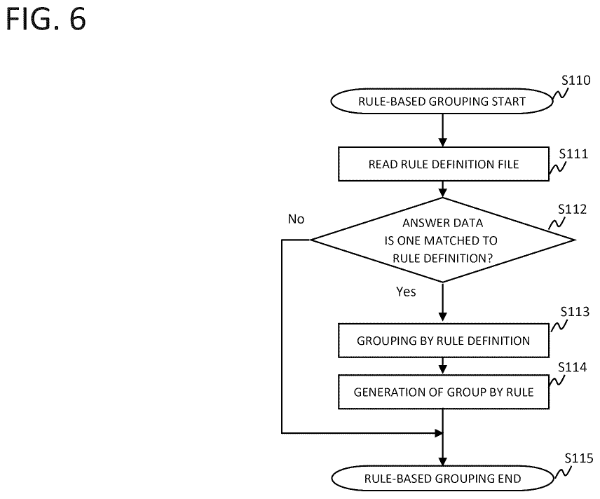

FIG. 6 is a flow diagram illustrating an example of a rule-based grouping processing of a grouping apparatus according to the present disclosure. In a grouping executed in step S104 of FIG. 5, first, a rule-based grouping processing as shown in FIG. 6 is executed as an example.

With reference to FIG. 6, a rule-based grouping processing starts as step S110. A rule definition reading part 220 reads rule definition from a rule definition file which defines grading criteria, and so on (step S111). FIG. 4 is a diagram illustrating an example of a rule definition. Rule definition is a data made up of a rule ID of column 500 and rule content of column 501. As a rule ID=3 shown in FIG. 4, a plurality of rules may be described by a plurality of rows. In this case, as an example, it is assumed that whether rule definition of a rule ID=3 is satisfied or not is determined by a condition in which rule contents of each row is combined by a logical product AND. That is, when rule definitions described in all rows are satisfied, it is determined that a rule definition is matched. It is determined whether it is an answer data that is matched to a defined rule. In a case where answer data is matched to rule definition (step S112 Yes), it is assigned to a group by a rule ID (step S113). Furthermore, after group assignment of answer data, a group by a rule ID is generated (step S114). Even if no answer data is assigned to a rule ID, a group by a rule ID is generated. A processing ends at step S115.

For answer data which has not corresponded to answer data matched to rule definition (step S112 No) by the group assignment in accordance with rule definition as shown in steps S110 to S115 in FIG. 6, following processing is performed in group analysis (step S104) as an example.

### [Processing in a Case of not Matching Rule Definition]

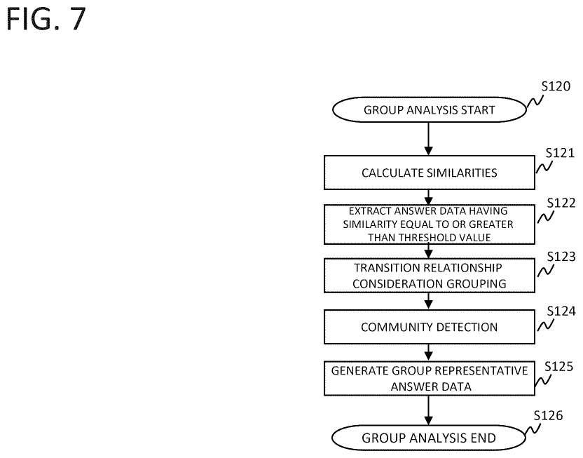

FIG. 7 is a flow diagram illustrating an example of a processing in a group analysis (step S104) as shown in FIG. 5 of a grouping apparatus according to the present disclosure. The processing starts at step S120. A similarity calculation part 222 calculate s similarities among all answer data (step S121). That is, similarities among all answer sentence vectors are calculated. In this time, any of a cos (cosine) similarity, Euclidean norm, and so on can be used for a calculation of similarity. In the first example embodiment, description will be made using a cos similarity as an example.

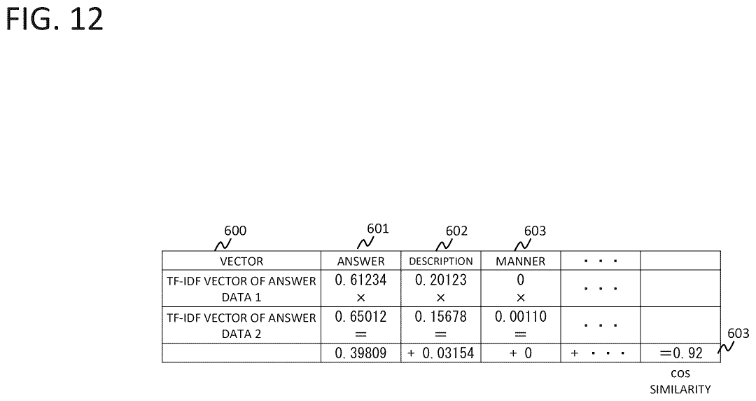

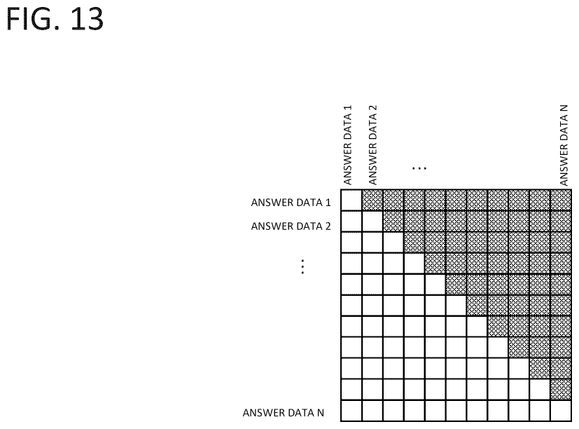

FIG. 12 is a diagram illustrating an example of a calculation of contributions and a cos similarity of a grouping apparatus according to the present disclosure. As an example, it is shown that a cos similarity between a TF-IDF vector of answer data 1 and a TF-IDF vector of answer data 2 in column 600 is calculated. Columns 601 to 603 are elements by morphological analysis. As an example, products of respective elements of a TF-IDF vector of answer data 1 and a TF-IDF vector of answer data 2 are calculated as contributions and a cos similarity is calculated as a sum of the contributions. With reference to FIG. 12, as an example, in a case where an answer sentence is “I don't know a manner of description of answer.”, “answer”, “description” and “manner” can be acquired by a morphological analysis. Note, if a TF-IDF vector of answer data 1 and a TF-IDF vector of answer data 2 is replaced with a centroid vector of a group 1 and a centroid vector of a group 2, the same applies. FIG. 13 is a diagram illustrating an example of relationships between cos similarities and answer data of a grouping apparatus according to the present disclosure. Duplication of each data 1 to N and a similarity of data itself are not necessarily be calculated, cos similarities for shaded portions are to be calculated. Note, in a case where a similarity is greater than or equal to a threshold value, it is decided that there exists a similarity relationship.

A high similarity answer data extraction part 223 shown in FIG. 2 extracts answer data having a similarity greater than or equal to a threshold value between respective pieces of answer data (step S122). In the first example embodiment, as an example, an answer sentence vector having a similarity greater than or equal to 0.4 is to be a subject.

A transition relationship consideration group division part 224 shown in FIG. 2 groups a network of high similarity answer data extracted at step S104 of FIG. 5 as a transition relationship consideration group (step S123). Even if there is a similarity relationship between answer data A and answer data B and there is a similarity relationship between answer data B and answer data C, but there is no similarity relationship between answer data A and answer data C, it is regarded to have a similarity relationship between answer data A and answer data C to be a transition relationship consideration group. That is, a similarity relationship network is assumed to be one transition relationship consideration group and to be regarded as one group.

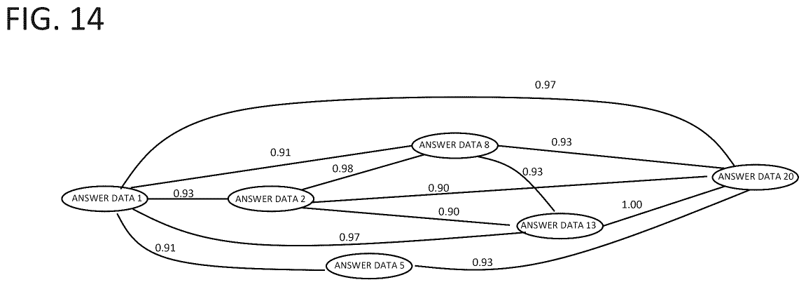

FIG. 14 is a diagram illustrating an example of an outline of transition relationship consideration groups of a grouping apparatus according to the present disclosure. It is assumed that numerical values denoted on respective lines connecting between respective answer data show similarity between the answer data. By extracting answer data having similarity greater than or equal to a threshold value, a network as shown in FIG. 14 can be acquired. Here, although there is no direct similar relationship between answer data 2 and answer data 5, they belong to the same network through answer data 1. Such an indirect similar relationship network is assumed to be “a transition relationship consideration group”.

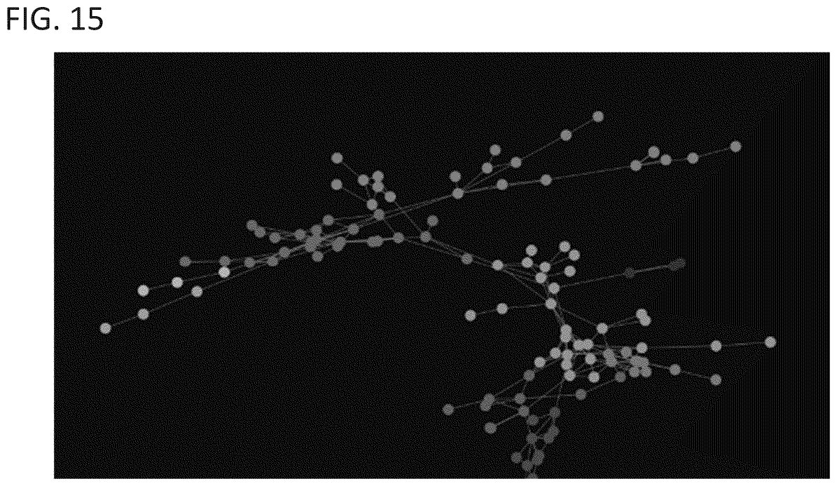

A community detection part 225 as shown in FIG. 2 divides a transition relationship consideration group using a community detection (step S124). There are several community detections based on such as edge betweenness centrality or random walk. However, in the first example embodiment, description will be made by using a greedy algorithm as an example of community detection. If one transition relationship consideration group becomes too big, one end and another end of a network may have different meanings. This is divided to communities using community detection which is a technology to divide a group into communities based on a shape of a graph. It is assumed that divided groups are final groups. FIG. 15 is a diagram illustrating an example of imagery of group division of a grouping apparatus according to the present disclosure. Circle s indicate answer data vectors and line(s) indicates a binding(s). The binding(s) will be described later.

A group representative answer data generation part 226 as shown in FIG. 2 generates data representing answer data of a group to be one answer data (step S125). A generation method may be extracting one representative case in a group or acquiring a summarized sentence by LLM (Large Language Model). Furthermore, a centroid vector of a group is calculated and an answer data nearest to the centroid vector may be selected. A processing ends at step S126.

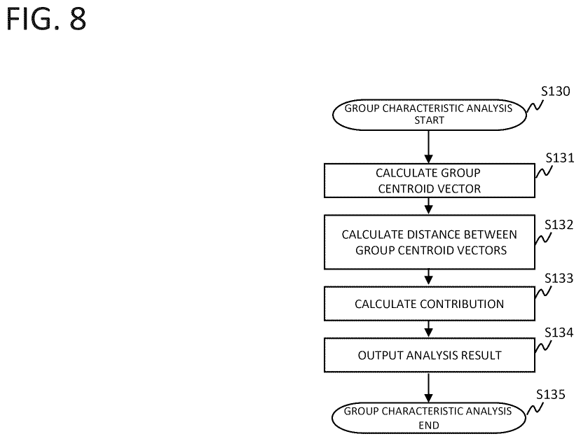

Returning to FIG. 5, a group characteristic analysis part 214 as shown in FIG. 1 performs group characteristic analysis of step S105 in FIG. 5 to analyze words characteristic to a particular group or word(s) common to a lot of groups. FIG. 8 is a flow diagram illustrating an example of a processing of a group characteristic analysis of a grouping apparatus according to the present disclosure, which illustrates detailed content performed in a group characteristic analysis processing of step S105 as shown in FIG. 5.

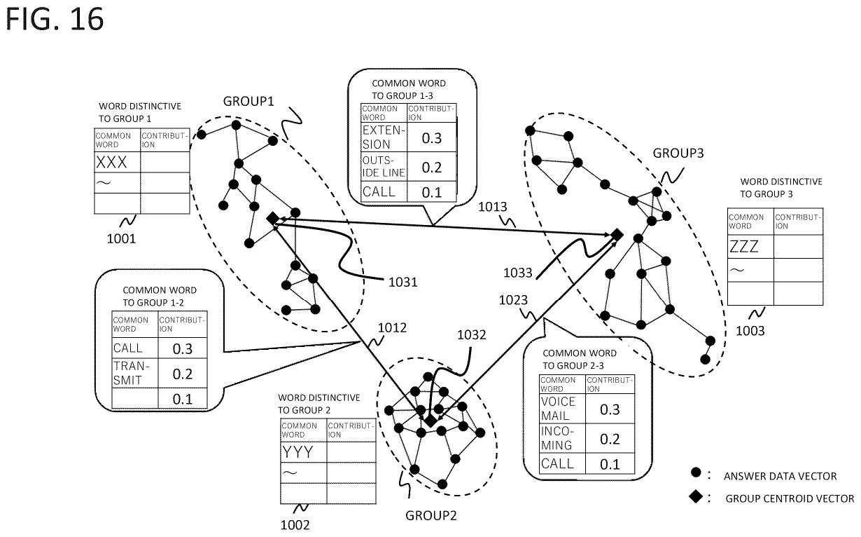

With reference to FIG. 8, a centroid vector of each group is calculated (step S131). A distance between groups is calculated based on a centroid vector of each group (step S132). Then, contribution is calculated as described later (step S133). With using contribution, statistical information, such as, word(s) commonly appeared among groups, word(s) with great difference among groups, word(s) distinctive to groups, word(s) common to all groups, and so on, is outputted as an analysis result (step S134). FIG. 16 is a diagram illustrating an example in which dimensionality of a space of answer data vectors is dimensionally reduced to two dimensions. FIG. 16 illustrates an example of a diagram displayed as statistical information.

Each point shown in FIG. 16 represents each answer data vector and points connected by a line show that they belong to the same group. Furthermore, a centroid vector of each group is indicated by a rectangle. Contribution is checked among centroid vectors and a word(s) having high contribution between groups is shown as a common word(s) (common term(s)). Low contribution word(s) for any group is shown as a word(s) distinctive to groups. That is, common word(s) between groups and word(s) distinctive to groups are displayed by dimension al reduction.

Contribution is calculated between vectors (centroid vectors) by vectorizing centroids of groups. As an example, let a TF-IDF vector of each answer data shown in FIG. 12 be a group centroid vector, each element of an inner product of vectors in a case of calculation cos similarity is contribution of each word.

A word having a high contribution among groups is a word(s) commonly appeared among groups. A word(s) having contribution of zero is a word(s) only appeared in one group. A word(s) appeared only in one group among all the groups is a word(s) distinctive to the one group. Re-grouping may be performed after vector weighting each word as described before according to an analysis result. The same analysis may be performed between communities.

Returning to FIG. 5, for example, an IDF (Inverse Document Frequency) vector may be used as another method for analysis between groups performed by a group characteristic analysis part 214 as shown in FIG. 1 in a group characteristic analysis in step S105 shown in FIG. 5. When a centroid vector of a group is calculated, an IDF vector may be calculated. It can be analyzed that a word having a large IDF value is a word appearing only in fewer groups and a word having a small IDF value is a word appearing in many groups.

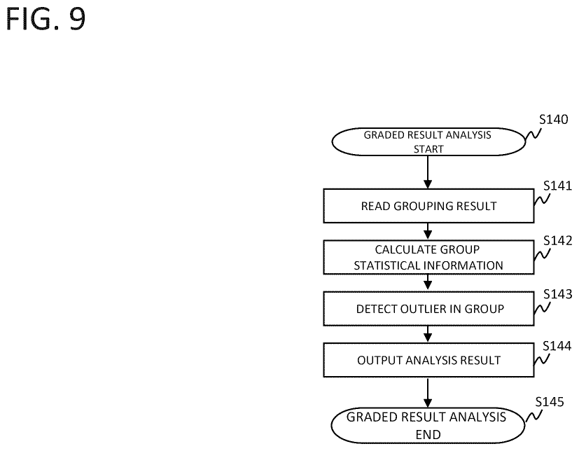

With reference to FIG. 5, a graded result analysis part 216 shown in FIG. 1 performs a graded result analysis in step S106 shown in FIG. 5. FIG. 9 is a flow diagram illustrating an example of a processing of a graded answer analysis of a grouping apparatus according to the present disclosure, which corresponds to a graded result analysis in Step S106 as shown in FIG. 5. A processing of a graded result analysis starts at step S140.

A graded result analysis part 216 reads a grouping result from a result storage part 300 (step S141). From graded results (scores) of all answer data in a group, statistical information, such as an average, a median, a standard deviation, a maximum value, a minimum value, and an interquartile range, and so on is calculated (step S142). Next, an outlier is detected from calculated statistical information (step S143). In the first example embodiment, description of a method is made using an interquartile range, as an example of a calculation method of an outlier. Let Q1 be a first quartile value (boundary of data points in the lower quarter (25%)) and Q3 be a third quartile value (boundary of data points in the higher quarter (25%)). At this time, an interquartile range can be acquired by Q3-Q1.

Using these, boundary of an outlier is calculated using following expressions and it is detected whether an outlier exists or not.

$$An outlier of a lower boundary = Q 1 - 1.5 \times an interquartile range , \\ An outlier of a higher boundary = Q 3 + 1.5 \times an interquartile range ,$$

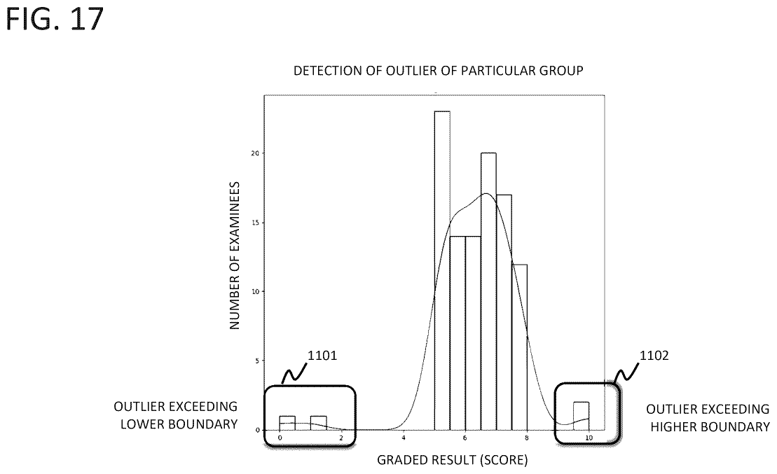

FIG. 17 is a diagram illustrating an example of an analysis of graded results, which illustrates an example of detection of an outlier of a particular group, that is, an outlier exceeding a higher boundary and an outlier exceeding a lower boundary.

A data point(s) exceeding the above scope is detected as an outlier(s). In a case where an outlier is detected, an outlier flag is set to an examinee ID of response data in question in a grouping result in a result storage part 300, as an example, to store in a result storage part 300.

An output part 217 shown in FIG. 1 refers to a grouping result in a result storage part 300 and outputs a group and an examinee ID information to which an outlier flag is set.

According to data grouping of the first example embodiment of the disclosure, it is possible to grouping answer sentences depending on graded results from large amounts of answer data without depending on manpower and without pre-training. Therefore, it is possible to significantly reduce time for preparation of data for model generation and needed for model training. Furthermore, it is possible to make correct groups by further dividing a group by a community detection. Unlike existing clustering, it is possible to perform grouping without prior designation of a number of clusters.

According to the first example embodiment of the present disclosure, it is possible to visualize group characteristics by calculating a centroid of a group and outputting statistical information of a centroid vector. It is possible to execute re-grouping again by setting parameters from the characteristics. As a result, it is possible to perform grouping more accurately.

As described above, it is possible to suppress variation of graded results and reduce the burden of a grader. Furthermore, the present disclosure can be utilized to grade answers solved in an exercise by a solver and also to assist for raising a score when a score is low.

Therefore, according to the first example embodiment of the present disclosure, it is possible to provide a grouping apparatus of graded answers of a descriptive examination, a grouping method of graded answers of a descriptive examination, and a program which contribute to suppress variation of graded results.

### Second Example Embodiment

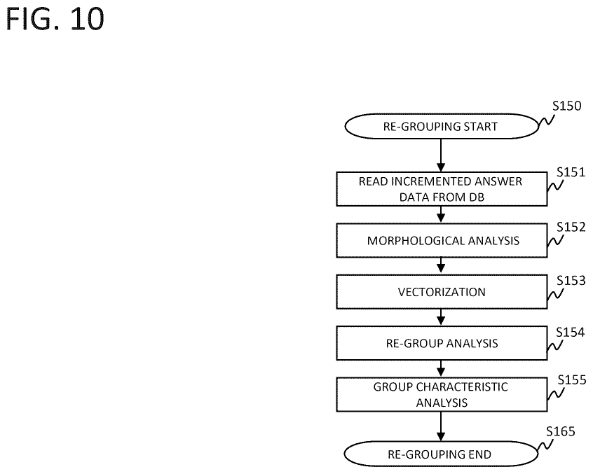

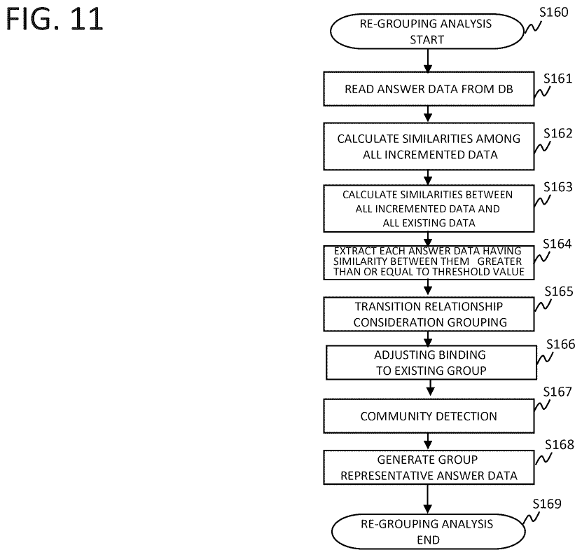

Next, a second example embodiment will be described in detail with reference to drawings. The second example embodiment is an example embodiment for increment data screening. FIG. 10 is a flow diagram illustrating an example of a processing of a re-grouping processing of a grouping apparatus according to the present disclosure. FIG. 11 is a flow diagram illustrating an example of a processing of a re-grouping analysis processing of a grouping apparatus according to the present disclosure. Note, FIG. 12 is referred to for an example of a configuration of a grouping apparatus and a configuration of a total system and FIG. 2 is referred to for an example of a configuration of a grouping execution part of the grouping apparatus.

There is one case where after grouping is once executed using answer data, a similar test is conducted and an answer for the similar test is to be coped with (for example, to verify validity of graded results of answers by solving past exam questions), and there is another case where a common test is performed all over the country and grading is performed in each region whereby a time at which graded results are to be returned is shifted. These cases are to be coped with. That is, total validity of contents of grading is ensured in a case where a time at which graded result is to be collected or returned is shifted. Increment data screening is to appropriately re-grouping by adding increment data to existing answer data.

With reference to FIG. 10, a processing of re-grouping starts at step S150. Next, a reading part of answer data 210 as shown in FIG. 1 reads increment data from a graded answer data storage part (also referred to DB) 100 (step S151). Increment data is assumed to indicate graded answer data stored after previous grouping was executed.

A morphological analysis part 211 as shown in FIG. 1 performs a morphological analysis of increment answer sentences (step S152). Among morphemes acquired as a result, parts of speech (particle and auxiliary verb) which are determined to be unnecessary may be excluded, they are necessary to be identical to parts of speech which was excluded at the time of a morphological analysis of existing data. A result of a morphological analysis is stored in a result storage part 300.

A vectorization part 212 vectorizes answer sentences which have been morphologically analyzed (step S153). At this time, particular word(s) may be weighted. In a case where word(s) is determined to be not important for grouping, a small value may be assigned, and in a case where word(s) is determined to be important for grouping, a large value may be assigned. A weighted vector may be normalized. For vectorization, any method, such as TF, TF-IDF, BM25, Word2Vec, Doc2Vec, and so on may be used, it is necessary to use the same method as that of an original answer sentence vector. In the following, description will be made using TF-IDF as an example. It is assumed that vectorized answer sentence is called an increment answer sentence vector. A result of vectorization is stored in a result storage part 300.

Next, a grouping execution part 213 performs a re-group analysis (step S154).

FIG. 11 is a flow diagram illustrating an example of a processing of a re-grouping analysis of a grouping apparatus according to the present disclosure. A processing of re-grouping will be described with reference to FIG. 11. A processing of re-grouping starts at step S160.

A grouping execution part 213 as shown in FIG. 1 reads answer sentence vectors of existing answer data from a result storage part (also referred to DB) 300 (step S161).

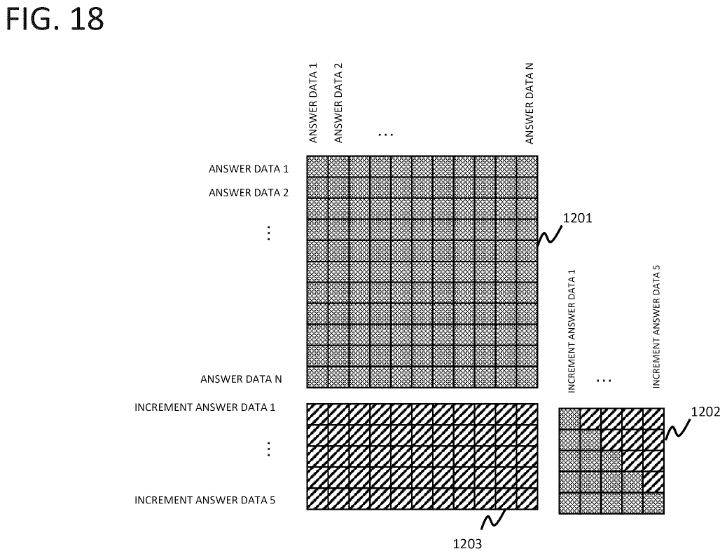

FIG. 18 is a diagram illustrating an example of an operation of calculating a cos similarity when increment data is re-grouped. In FIG. 18, it is assumed that similarity checks between existing data shown by a reference sign 1201 have been finished. Next, a similarity calculation part 222 as shown in FIG. 2 calculates similarities among all increment data as shown by hatched parts of a reference sign 1202 in FIG. 18 (step S162). That is, similarities among all increment answer sentence vectors are calculated. In this time, any of a cos similarity, Euclidean norm, and so on can be used for a similarity, but it is necessary to use the same method as that of similarity calculation of the existing data.

Next, as shown by a reference sign 1203, a similarity calculation part 222 calculates similarities between all increment data and all existing data (step S163). In this time, any of a cos similarity, Euclidean norm, and so on can be used for a similarity, but it is necessary to use the same method as that of similarity calculation of the existing data.

A high similarity answer data extraction part 223 as shown in FIG. 2 extracts answer data having a similarity between each answer data greater than or equal to a threshold value (step S164). A threshold value at this time is necessary to be the same as that for existing data. As an example, an answer sentence vector having a similarity greater than or equal to 0.4 is a subject.

A transition relationship consideration group division part 224 groups a network of high similarity answer data extracted at step S164 as a transition relationship consideration group (step S165).

At this time, it is expected that there are 6 similarity relationships between increment data and existing data below.
(1) increment data being not grouped is binding to one existing group,
(2) increment data being not grouped is binding to a plurality of existing groups,
(3) any increment data being not grouped is binding to no existing group,
(4) increment data being grouped is binding to one existing group,
(5) increment data being grouped is binding to a plurality of existing groups, and
(6) any increment data being grouped is binding to no existing group.

Note, although it is assumed that a term “binding” indicates that a similarity between each answer data is greater than or equal to a threshold value and a term “not binding” indicates that a similarity between each answer data is smaller than a threshold value, but not limited to above.

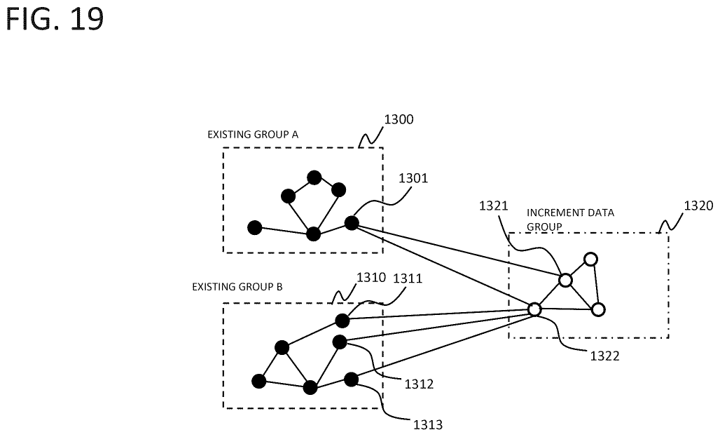

A group binding adjusting part 215 shown in FIG. 1 adjusts binding for respective 6 patterns as described above (step S166). In a case of a similarity relationship of (1), binding increment data is added to an existing group. In a case of similarity relationships of (3) and (6), it is not necessary to consider re-grouping because of being not binding to any existing group and they are remained as it is. In a case of similarity relationships of (2), (4) and (5), it can be said that one increment data is binding to a plurality of groups. In this case, increment data is added to a group having more numbers of bindings and bindings to other groups are removed. In a case where there are a plurality of groups having the same number of bindings, increment data is added to a group having bindings of a higher similarity and bindings to other groups are removed. A group after this operation is executed is assumed to be a group which is added for increment data. FIG. 19 to FIG. 22 illustrate operations in a case where increment data and existing data are binding to.

Each of FIG. 19 to FIG. 24 is a diagram illustrating an example of an operation of re-grouping of transition relationship consideration groups. With reference to FIG. 19, it is assumed that data 1321 of an increment data group 1320 is binding to data 1301 of an existing data group A 1300, and data 1322 of an increment data group 1320 is binding to data 1301 of an existing data group A 1300, data 1311, data 1312 and data 1313 of an existing data group B 1310.

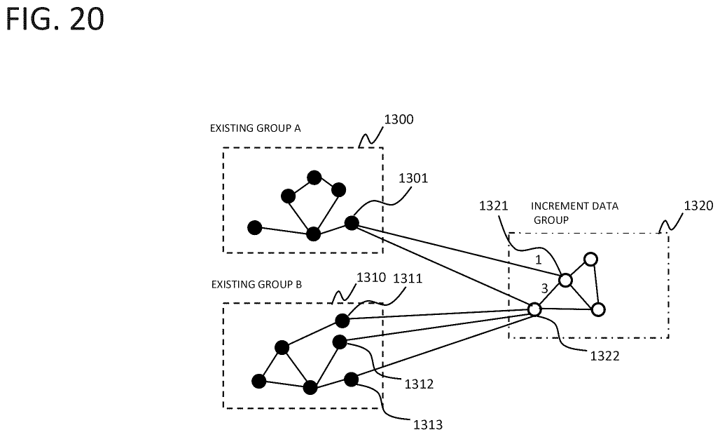

With reference to FIG. 20, data 1321 of an increment data group 1320 has one binding to an existing data group A 1300 and three bindings to an increment data group 1320. Therefore, data 1321 is made belong to an increment data group 1320.

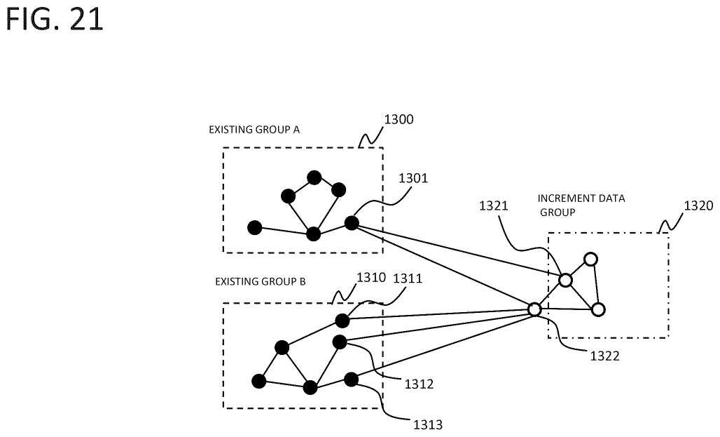

With reference to FIG. 21, data 1322 of an increment data group 1320 has one binding to an existing data group A 1300 and three bindings to an existing data group B 1310 and two bindings to an increment data group 1320. Therefore, data 1322 is made belong to an existing data group B 1310.

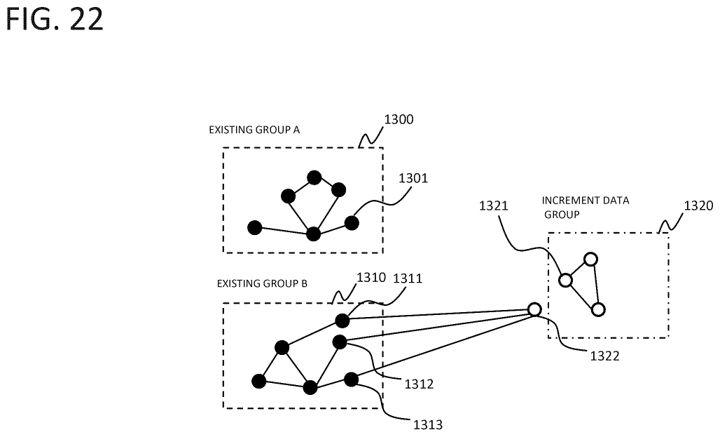

With reference to FIG. 22, data 1321 of an increment data group 1320 belongs to an increment data group 1320 and data 1322 belongs to an existing data group B 1310.

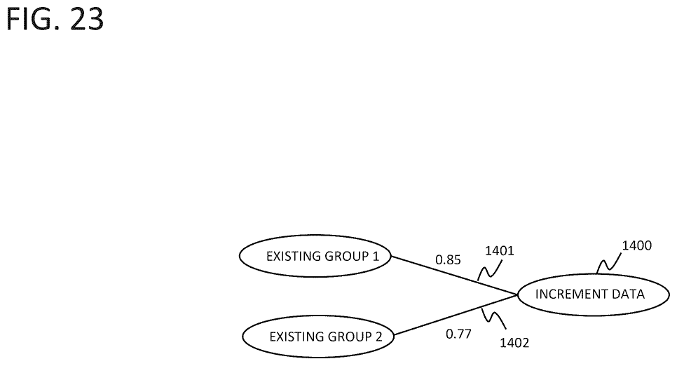

With reference to FIG. 23, in a case where increment data 1400 is binding to different two groups, as an example, an existing group 1 and an existing group 2 via one binging respectively, increment data 1400 is added to an existing group 1 having a high similarity binding 1401 in a binding 1401 and a binding 1402.

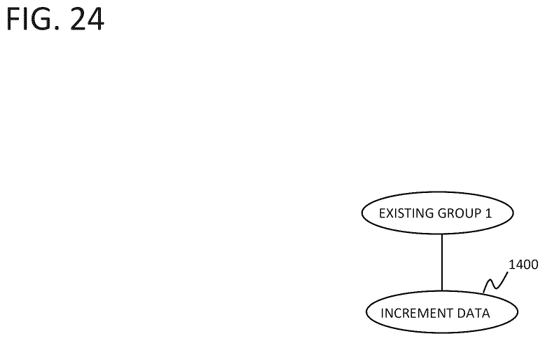

With reference to FIG. 24, in a case where increment data 1400 not being grouped is binding to an existing group 1, as an example, via one binding, increment data 1400 is added to the existing group 1.

A community detection part 225 shown in FIG. 2 divides transition relationship consideration group created in step S166 using a community detection (step S167). There are several community detections such as based on edge betweenness centrality or based on random walk. As an example, however, description will be made by exemplarily using community detection based on a greedy algorithm.

A group representative answer data generation part 226 as shown in FIG. 2 generates data representing answer data of a group to be one answer data (step S168). A generation method may be a way of extracting one representative case in a group or may be a way of acquiring a summarized sentence by LLM. It may be a way of calculating a centroid vector of a group and selecting answer data nearest to the centroid vector.

A processing of re-grouping ends at step S169 and returns to step S155 of FIG. 10.

Step S155 shown in FIG. 10 is a group characteristic analysis which is a processing corresponding to step S105 as shown in FIG. 5 to analyze word(s) characteristic to a particular group or word(s) common to a lot of groups in a group characteristic analysis part 214. Because its detailed processings correspond to processings from step S121 to step S124 shown in FIG. 7 described in the first example embodiment, description will be omitted.

Note, processing flows of elements, such as, a graded answer data storage part 100, a grouping apparatus (grouping function part) 200, a result storage part 300 are mainly described above, the present disclosure may be made up by a grading assisting apparatus, a grading assisting system, a virtual server on a cloud.

The example embodiments of the present invention have been described above, however, the present invention is not limited thereto. Further modifications, substitutions, or adjustments can be made without departing from the basic technical concept of the pre sent invention. For example, the configurations of the network and the elements and the representation modes of the message or the like illustrated in the individual drawings are merely used as examples to facilitate the understanding of the present invention. Thus, the present invention is not limited to the configurations illustrated in the drawings. In addition, “A and/or B” signifies at least any one of A or B.

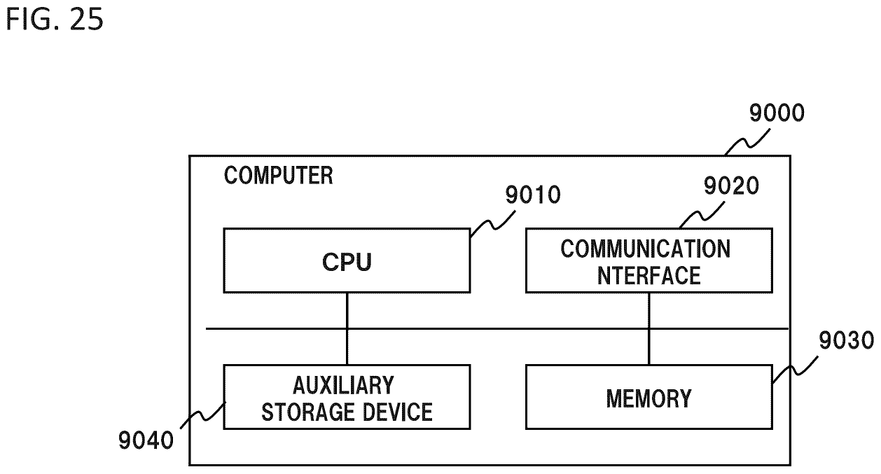

In addition, the procedures described in the above first to second example embodiments can each be realized by a program causing a computer (9000 in FIG. 25) functioning as the grouping apparatus of graded answers of a descriptive examination to realize the functions as the grouping apparatus of graded answers of a descriptive examination according to the present invention. For example, this computer is configured to include a CPU (Central Processing Unit) 9010, a communication interface 9020, a memory 9030, and an auxiliary storage device 9040 in FIG. 25. That is, the CPU 9010 in FIG. 25 executes a control program of the grouping apparatus of graded answers of a descriptive examination and performs processing for updating various calculation parameters stored in the auxiliary storage device 9040 or the like.

The memory 9030 is a RAM (Random Access Memory) or a ROM (Read-Only Memory), and so on.

That is, the individual parts (processing means, functions) of each of the grouping apparatus of graded answers of a descriptive examination in the first to second example embodiments as described above can each be realized by a computer program that causes a processor of the computer to execute the corresponding processing described above by using corresponding hardware.

Finally, suitable modes of the present disclosure will be summarized.

### [Mode 1]

A grouping apparatus of graded answers of a descriptive examination, may include
a reading part which reads graded answer data of a descriptive examination.

A grouping apparatus may include a morphological analysis part which performs morphological analysis of the answer data.

A grouping apparatus may include a vectorization part which vectorizes the result of the morphological analysis to an answer sentence vector.

A grouping apparatus may include a grouping execution part which groups the answer data matching a rule definition and groups the answer data which does not comply with the rule definition based on the answer sentence vector to generate a group.

A grouping apparatus may include a group characteristic analysis part which analyzes statistical information of features of the group generated.

A grouping apparatus may include a graded result analysis part which analyzes statistical information of a graded result of each of the groups.

A grouping apparatus may include an output part which outputs statistical information of characteristic of the group and statistical information of graded results.

### [Mode 2]

In the grouping apparatus of graded answers of a descriptive examination according to mode 1,
it is preferable that the grouping execution part calculates similarities among all answer data which do not match the rule definition, and groups the answer data with similarities greater than or equal to a threshold value to generate the group.

### [Mode 3]

In the grouping apparatus of graded answers of a descriptive examination according to mode 1,
it is preferable that the grouping execution part groups a transition relationship consideration group as one group.

### [Mode 4]

In the grouping apparatus of graded answers of a descriptive examination according to mode 2,
it is preferable that the grouping execution part calculates the similarity based on the answer sentence vectors.

### [Mode 5]

In the grouping apparatus of graded answers of a descriptive examination according to mode 4,
it is preferable that the similarity is a cosine similarity or Euclidean norm.

### [Mode 6]

In the grouping apparatus of graded answers of a descriptive examination according to mode 1,
it is preferable that the group characteristic analysis part analyzes statistical information of characteristic words for each group and common words to a plurality of the groups.

### [Mode 7]

The grouping apparatus of graded answers of a descriptive examination according to mode 1, may further include
a group binding adjusting part which adjusts to bind the increment answer data to respective groups of processed answer data when answer data is incremented.

### [Mode 8]

In the grouping apparatus of graded answers of a descriptive examination according to mode 7,
it is preferable that the group binding adjusting part adjusts binding of the increment data,
by adding increment data to an existing group in a case where the increment data not being grouped is binding to the only one existing group, and
by adding the increment data to the existing group having most numbers of bindings in a case where one increment data is binding to a plurality of existing groups.

### [Mode 9]

A grouping method of graded answers of a descriptive examination, may include that a computer reads graded answer data of a descriptive examination.

The computer may perform morphological analysis of the answer data,

The computer may vectorize the result of the morphological analysis to an answer sentence vector.

The computer may group the answer data matching a rule definition and group the answer data which does not comply with the rule definition based on the answer sentence vector to generate a group.

The computer may analyze statistical information of features of the group generated.

The computer may analyze statistical information of a graded result of each of the groups.

The computer may output statistical information of characteristic of the group and statistical information of graded results.

### [Mode 10]

A program may cause a computer to perform a processing of
reading graded answer data of a descriptive examination;

The program may cause the computer to perform a processing of performing morphological analysis of the answer data.

The program may cause the computer to perform a processing of vectorizing the result of the morphological analysis to an answer sentence vector.

The program may cause the computer to perform a processing of grouping the answer data matching a rule definition and grouping the answer data which does not comply with the rule definition based on the answer sentence vector to generate a group.

The program may cause the computer to perform a processing of analyzing statistical information of features of the group generated.

The program may cause the computer to perform a processing of analyzing statistical information of a graded result of each of the groups.

The program may cause the computer to perform a processing of outputting statistical information of characteristic of the group and statistical information of graded results.

Note, the above modes 9 and 10 can be expanded to the modes 2 to 8 in the same way as the mode 1 is expanded.

The disclosure of each of the above PTLs is incorporated herein by reference thereto. Modifications and adjustments of the example embodiments or examples are possible within the scope of the overall disclosure (including the claims) of the pre sent invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description disclose s numerical value ranges. However, even if the description does not particularly disclose arbitrary numerical values or small ranges included in the ranges, these values and ranges should be construed to have been concretely disclosed. Furthermore, it is also considered that a matter used to combine part or all of each of the disclosed matters of the above-cited documents with the matters described in this document as a part of the disclosure of the present invention, in accordance with the gist of the present invention, if necessary, is included in the disclosed matters of the present application.

### REFERENCE SIGNS LIST

100 graded answer data storage part
110 graded answer data of CBT test
120 scanner
130 graded answer sheet
140 rule definition
200 grouping apparatus
210 reading part of answer data
211 morphological analysis part
212 vectorization part
213 grouping execution part
214 group characteristic analysis part
215 group binding adjusting part
216 graded result analysis part
217 output part
220 rule definition reading part
221 rule-based group dividing part
222 similarity calculation part
223 high similarity answer data extraction part
224 transition relationship consideration group division part
225 community detection part
226 group representative answer data generation part
300 result storage part
9000 computer
9010 CPU
9020 communication interface
9030 memory
9040 auxiliary storage device

What is claimed is:

1. A grouping apparatus of graded answers of a descriptive examination, comprising:
at least a processor; and
a memory in circuit communication with the processor;
wherein the processor is configured to execute program instruction stored in the memory to perform:
reading graded answer data of a descriptive examination;
performing morphological analysis of the answer data;
vectorizing a result of the morphological analysis to an answer sentence vector;
grouping the answer data matching a rule definition and grouping the answer data which does not comply with the rule definition based on the answer sentence vector to generate a group(s);
analyzing statistical information of features of the group(s) generated;
analyzing statistical information of a graded result of each of the groups; and
outputting statistical information of characteristic of the group(s) and statistical information of graded results.

2. The grouping apparatus of graded answers of a descriptive examination according to claim 1,
wherein the grouping the answer data comprises calculating similarities among all answer data which do not match the rule definition, and groups the answer data with similarities greater than or equal to a threshold value to generate the group(s).

3. The grouping apparatus of graded answers of a descriptive examination according to claim 1,
wherein the grouping the answer data comprises grouping a transition relationship consideration group as one group.

4. The grouping apparatus of graded answers of a descriptive examination according to claim 2,
wherein the grouping the answer data comprises calculating the similarity based on the answer sentence vectors.

5. The grouping apparatus of graded answers of a descriptive examination according to claim 1,
wherein the analyzing statistical information comprises analyzing statistical information of characteristic word(s) for each group and common word(s) to a plurality of the groups.

6. The grouping apparatus of graded answers of a descriptive examination according to claim 1, wherein the processor is configured to execute the program instructions to implement:
adjusting to bind the increment answer data to respective groups of processed answer data when answer data is incremented.

7. The grouping apparatus of graded answers of a descriptive examination according to claim 6,
wherein the adjusting comprises adjusting binding of the increment data,
by adding increment data to an existing group in a case where the increment data not being grouped is binding to the only one existing group, and
by adding the increment data to the existing group having most numbers of bindings in a case where one increment data is binding to a plurality of existing groups.

8. A grouping method of graded answers of a descriptive examination, comprising: by a computer,
reading graded answer data of a descriptive examination;
performing morphological analysis of the answer data;
vectorizing a result of the morphological analysis to an answer sentence vector;
grouping the answer data matching a rule definition and grouping the answer data which does not comply with the rule definition based on the answer sentence vector to generate a group(s);
analyzing statistical information of features of the group(s) generated;
analyzing statistical information of a graded result of each of the groups; and
outputting statistical information of characteristic of the group(s) and statistical information of graded results.

9. The grouping method of graded answers of a descriptive examination according to claim 8,
wherein the grouping the answer data comprises calculating similarities among all answer data which do not match the rule definition, and groups the answer data with similarities greater than or equal to a threshold value to generate the group(s).

10. The grouping method of graded answers of a descriptive examination according to claim 8,
wherein the grouping the answer data comprises grouping a transition relationship consideration group as one group.

11. The grouping method of graded answers of a descriptive examination according to claim 9,
wherein the grouping the answer data comprises calculating the similarity based on the answer sentence vectors.

12. The grouping method of graded answers of a descriptive examination according to claim 8,
wherein the analyzing statistical information comprises analyzing statistical information of characteristic word(s) for each group and common word(s) to a plurality of the groups.

13. The grouping method of graded answers of a descriptive examination according to claim 8, wherein the computer is configured to execute the program instructions to implement:
adjusting to bind the increment answer data to respective groups of processed answer data when answer data is incremented.

14. A computer-readable non-transitory recording medium recording a program, the program causes a computer to perform processings of:
reading graded answer data of a descriptive examination;
performing morphological analysis of the answer data;
vectorizing a result of the morphological analysis to an answer sentence vector;
grouping the answer data matching a rule definition and grouping the answer data which does not comply with the rule definition based on the answer sentence vector to generate a group(s);
analyzing statistical information of features of the group(s) generated;
analyzing statistical information of a graded result of each of the groups; and
outputting statistical information of characteristic of the group(s) and statistical information of graded results.

15. The computer-readable non-transitory recording medium recording a program according to claim 14,
wherein the grouping the answer data comprises calculating similarities among all answer data which do not match the rule definition, and groups the answer data with similarities greater than or equal to a threshold value to generate the group(s).

16. The computer-readable non-transitory recording medium recording a program according to claim 14,
wherein the grouping the answer data comprises grouping a transition relationship consideration group as one group.

17. The computer-readable non-transitory recording medium recording a program according to claim 15,
wherein the grouping the answer data comprises calculating the similarity based on the answer sentence vectors.

18. The computer-readable non-transitory recording medium recording a program according to claim 14,
wherein the analyzing statistical information comprises analyzing statistical information of characteristic word(s) for each group and common word(s) to a plurality of the groups.

19. The computer-readable non-transitory recording medium recording a program according to claim 14,
wherein the program causes a computer to perform processings of:
adjusting to bind the increment answer data to respective groups of processed answer data when answer data is incremented.

20. The computer-readable non-transitory recording medium recording a program according to claim 19,
wherein the adjusting comprises adjusting binding of the increment data,
by adding increment data to an existing group in a case where the increment data not being grouped is binding to the only one existing group, and
by adding the increment data to the existing group having most numbers of bindings in a case where one increment data is binding to a plurality of existing groups.
